(19) United States
(12) Patent Application Publication
(10) Pub. No.: US 2026/0160646 A1
(43) Pub. Date: Jun. 11, 2026

(54) WHEEL LOAD ESTIMATION DEVICE, WHEEL LOAD ESTIMATION METHOD, AND WHEEL LOAD ESTIMATION PROGRAM

(71) Applicant: Sumitomo Rubber Industries, Ltd., Kobe-shi (JP)

(72) Inventors: Shuhei NARITA, Kobe-shi (JP); Tomoyuki URABE, Kobe-shi (JP); Yuzo KAWASAKI, Kobe-shi (JP)

(73) Assignee: Sumitomo Rubber Industries, Ltd., Kobe-shi (JP)

(21) Appl. No.: 19/178,810

(22) Filed: Apr. 14, 2025

(30) Foreign Application Priority Data
Apr. 26, 2024 (JP) 2024-072561

(51) Int. Cl. G01M 17/013; B60C 23/04

(52) U.S. Cl. CPC G01M 17/013; B60C 23/0488

(57) ABSTRACT

A wheel load estimation device can include a tire information acquisition unit, a wheel speed acquisition unit, a frequency characteristic ratio calculation unit, a load ratio calculation unit, and a wheel load calculation unit. The tire information acquisition unit can acquire type information specifying a type of a tire. The wheel speed acquisition unit can acquire wheel speed information representing wheel speed of each wheel of a vehicle. The frequency characteristic ratio calculation unit can calculate front-rear and left-right frequency characteristic ratios. The load ratio calculation unit can calculate front-rear and left-right load ratios. The wheel load calculation unit can calculate a wheel load ratio representing a relative wheel load. The load ratio calculation unit can calculate the front-rear and left-right load ratios, based on first relationship specification information and second relationship specification information, respectively.

### CROSS-REFERENCE TO RELATED APPLICATION

This application claims the benefit of foreign priority to Japanese Patent Applications No. JP 2024-072561, filed Apr. 26, 2024, which is hereby incorporated by reference in its entirety.

### BACKGROUND

### Field

The present disclosure relates to a technology for estimating a wheel load of a tire included in a vehicle.

Japanese Laid-Open Patent Publication No. 2019-113373 describes a wheel load estimation device that can accurately estimate a wheel load with simple equipment. The wheel load estimation device estimates the load ratio of each wheel by utilizing the fact that the frequency characteristics of a rotating wheel change in accordance with a change in the wheel load. More specifically, in Japanese Laid-Open Patent Publication No. 2019-113373, integrated gain values of frequency spectra are derived for two front wheels, two rear wheels, two left wheels, and two right wheels, respectively, from output signals of wheel speed sensors for detecting the wheel speeds of the respective wheels. According to Japanese Laid-Open Patent Publication No. 2019-113373, the front-rear ratio and the left-right ratio of these integrated gain values are in an approximately linear relationship with the front-rear ratio and the left-right ratio of the wheel loads, respectively. Therefore, if coefficients that specify the above linear relationship are obtained in advance, the load ratio of each wheel is estimated based on the integrated gain values derived based on the output signals of the wheel speed sensors for the respective wheels. Furthermore, if the total weight of the vehicle body is separately estimated, the wheel load of each wheel can be estimated.

However, the frequency characteristics of each wheel speed vary depending on the type of the tire. Therefore, depending on the tires included in the vehicle, the linear relationship between the front-rear ratio of the integrated gain values and the front-rear ratio of the wheel loads may deviate from the above pre-specified linear relationship, which may reduce the accuracy of the wheel load estimation. The same applies to the linear relationship between the left-right ratio of the integrated gain values and the left-right ratio of the wheel loads.

### SUMMARY

A wheel load estimation device according to a first aspect of the present disclosure can be or include a wheel load estimation device configured to estimate a wheel load of a tire included in a vehicle. The wheel load estimation device can include a tire information acquisition unit, a wheel speed acquisition unit, a frequency characteristic ratio calculation unit, a load ratio calculation unit, and a wheel load calculation unit. The tire information acquisition unit can acquire type information specifying a type of the tire. The wheel speed acquisition unit can acquire wheel speed information representing a wheel speed of each wheel of the vehicle. The frequency characteristic ratio calculation unit can calculate a front-rear frequency characteristic ratio and a left-right frequency characteristic ratio, based on the wheel speed information, the front-rear frequency characteristic ratio changing in accordance with a change in a front-rear load ratio which is a ratio between a load applied to a front wheel of the vehicle and a load applied to a rear wheel of the vehicle, the left-right frequency characteristic ratio changing in accordance with a change in a left-right load ratio which is a ratio between a load applied to a left wheel of the vehicle and a load applied to a right wheel of the vehicle. The load ratio calculation unit can calculate the front-rear load ratio and the left-right load ratio, based on the front-rear frequency characteristic ratio and the left-right frequency characteristic ratio, respectively. The wheel load calculation unit can calculate a wheel load ratio representing a relative wheel load between the wheels included in the vehicle, with respect to at least one wheel of the vehicle, based on the front-rear load ratio and the left-right load ratio. The load ratio calculation unit can calculate the front-rear load ratio and the left-right load ratio, based on first relationship specification information specifying a relationship between the front-rear frequency characteristic ratio and the front-rear load ratio and second relationship specification information specifying a relationship between the left-right frequency characteristic ratio and the left-right load ratio, respectively. The first relationship specification information and the second relationship specification information can be determined according to the type of the tire.

A wheel load estimation device according to a second aspect can be or include the wheel load estimation device according to the first aspect, wherein at least one of the tires can include a tag in which the type information is electromagnetically stored.

A wheel load estimation device according to a third aspect can be or include the wheel load estimation device according to the first or second aspect, wherein the first relationship specification information and the second relationship specification information can be stored in a computer external to the vehicle, and the load ratio calculation unit can acquire the first relationship specification information and the second relationship specification information from the external computer.

A wheel load estimation system according to a fourth aspect can include: the wheel load estimation device according to the first aspect; at least one tire including a tag in which the type information is electromagnetically stored; and a reader configured to read out the type information from the tag.

A wheel load estimation method according to a fifth aspect can be or include a wheel load estimation method, executed by one or more computers, for estimating a wheel load of a tire included in a vehicle, and can include the following.
Acquiring type information specifying a type of the tire.
Acquiring wheel speed information representing a wheel speed of each wheel of the vehicle.
Calculating a front-rear frequency characteristic ratio and a left-right frequency characteristic ratio, based on the wheel speed information, the front-rear frequency characteristic ratio changing in accordance with a change in a front-rear load ratio which is a ratio between a load applied to a front wheel of the vehicle and a load applied to a rear wheel of the vehicle, the left-right frequency characteristic ratio changing in accordance with a change in a left-right load ratio which is a ratio between a load applied to a left wheel of the vehicle and a load applied to a right wheel of the vehicle.
Calculating the front-rear load ratio and the left-right load ratio, based on the front-rear frequency characteristic ratio and the left-right frequency characteristic ratio, respectively.
Calculating a wheel load ratio representing a relative wheel load between the wheels included in the vehicle, with respect to at least one wheel of the vehicle, based on the front-rear load ratio and the left-right load ratio.
The calculating the front-rear load ratio and the left-right load ratio can include calculating the front-rear load ratio and the left-right load ratio, based on first relationship specification information specifying a relationship between the front-rear frequency characteristic ratio and the front-rear load ratio and second relationship specification information specifying a relationship between the left-right frequency characteristic ratio and the left-right load ratio, respectively, and the first relationship specification information and the second relationship specification information can be determined according to the type of the tire.

A wheel load estimation program according to a sixth aspect can be or include a wheel load estimation program for estimating a wheel load of a tire included in a vehicle, and causes one or more computers to execute the following.
Acquiring type information specifying a type of the tire.
Acquiring wheel speed information representing a wheel speed of each wheel of the vehicle.
Calculating a front-rear frequency characteristic ratio and a left-right frequency characteristic ratio, based on the wheel speed information, the front-rear frequency characteristic ratio changing in accordance with a change in a front-rear load ratio which is a ratio between a load applied to a front wheel of the vehicle and a load applied to a rear wheel of the vehicle, the left-right frequency characteristic ratio changing in accordance with a change in a left-right load ratio which is a ratio between a load applied to a left wheel of the vehicle and a load applied to a right wheel of the vehicle.
Calculating the front-rear load ratio and the left-right load ratio, based on the front-rear frequency characteristic ratio and the left-right frequency characteristic ratio, respectively.
Calculating a wheel load ratio representing a relative wheel load between the wheels included in the vehicle, with respect to at least one wheel of the vehicle, based on the front-rear load ratio and the left-right load ratio.
The calculating the front-rear load ratio and the left-right load ratio can include calculating the front-rear load ratio and the left-right load ratio, based on first relationship specification information specifying a relationship between the front-rear frequency characteristic ratio and the front-rear load ratio and second relationship specification information specifying a relationship between the left-right frequency characteristic ratio and the left-right load ratio, respectively, and the first relationship specification information and the second relationship specification information can be determined according to the type of the tire.

### BRIEF DESCRIPTION OF THE DRAWINGS

FIG. 1 is a schematic diagram showing a situation in which a wheel load estimation device according to one or more embodiments of the present may be installed in a vehicle;

FIG. 2 is a block diagram showing the electrical configuration of the wheel load estimation device;

FIG. 3 is a flowchart showing the flow of wheel load estimation processing;

FIG. 4 is a schematic diagram of a wheel load estimation system according to a modification; and

FIG. 5 is a diagram of a configuration example of a database.

### DETAILED DESCRIPTION

An object of one or more embodiments of the present disclosure, among one or more objects, can be to provide a wheel load estimation device, a wheel load estimation method, and/or a wheel load estimation program that can accurately estimate a wheel load.

Thus, according to one or more embodiments of the present disclosure, it can be possible to more accurately estimate the wheel load of the tire included in the vehicle.

Hereinafter, a wheel load estimation device, a wheel load estimation method, and a wheel load estimation program according to one or more embodiments of the present disclosure will be described with reference to the drawings.

### 1. Configuration of Wheel Load Estimation Device

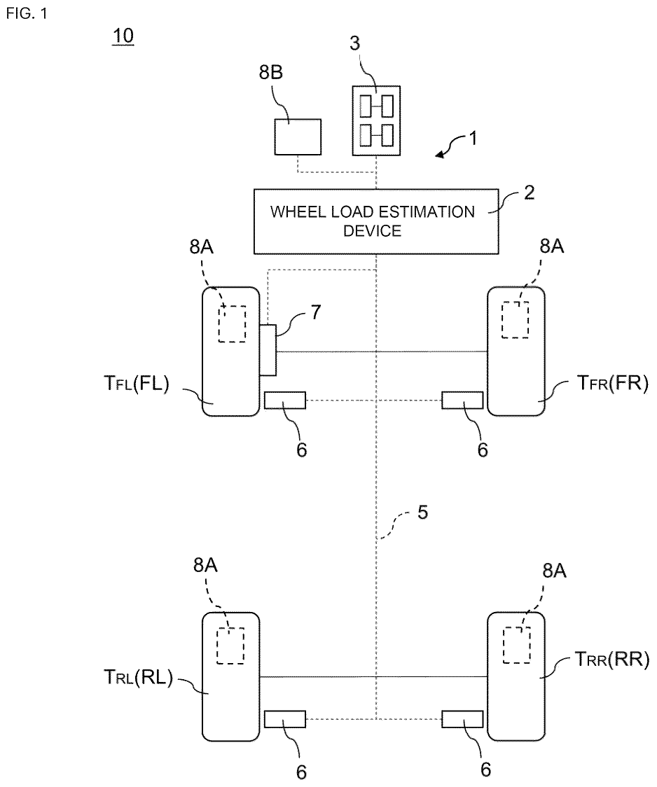

FIG. 1 is a schematic diagram showing a situation in which a wheel load estimation device 2 according to the present embodiment is installed in a vehicle 1. The vehicle 1 is a four-wheel vehicle, and includes a front-left wheel FL, a front-right wheel FR, a rear-left wheel RL, and a rear-right wheel RR. Tires T_{FL}, T_{FR}, T_{RL}, and T_{RR} are mounted on the wheels FL, FR, RL, and RR, respectively. The wheel load estimation device 2 has a function of estimating wheel loads applied to these wheels FL, FR, RL, and RR (or tires T_{FL}, T_{FR}, T_{RL}, and T_{RR}).

Data on the estimated wheel loads may be utilized for various controls for assisting the vehicle 1 in running. For example, the data on the estimated wheel loads may be transmitted to a brake control system, and can be utilized for brake control. In addition, the data on the estimated wheel loads may be transmitted to a tire pressure monitoring system (TPMS) or the like mounted on the wheels FL, FR, RL, and RR, and can be utilized for determining deflation of each tire. In the TPMS, if deflation of a tire is detected based on the data on the estimated wheel loads, a warning about the detection can be issued via a warning indicator 3 installed in the vehicle 1. For the TPMS, there is a method for determining deflation of a tire based on a change in the dynamic load radius of the tire, and the dynamic load radius of the tire is influenced not only by deflation of the tire but also by the wheel load. Therefore, if this method is adopted, the influence of the wheel load may be cancelled out of the dynamic load radius of the tire based on the data on the estimated wheel loads, whereby deflation of the tire can be accurately determined. Overloading or unbalanced loading for the vehicle 1 can also be detected based on the data on the estimated wheel loads, and upon this being detected, a warning about the detection can be issued via the warning display 3 installed in the vehicle 1. Overloading, according to one or more embodiments of the present disclosure, can be or mean a state where loads that exceed an allowable load capacity are placed on the vehicle 1, and unbalanced loading can be or more mean a state where loads are unbalanced in the vehicle 1.

At least one of the tires T_{FL}, T_{FR}, T_{RL}, and T_{RR} of the present embodiment includes a tag 8A in which type information specifying the type of the tire is electromagnetically stored. More specifically, the tag 8A is composed of a known RFID tag having a built-in memory for storing information, for example, and is embedded in the rubber constituting the tire T_{FL}, T_{FR}, T_{RL}, or T_{RR}. The type information specifying the type of the tire may be information by which the tire name and the tire size of the tire can be specified. In addition, individual identification information identifying the individual tire, specification information indicating the specifications other than the size of the tire, production information regarding production such as the production date, etc., may be stored in the memory of the tag 8A.

The information stored in the memory in the tag 8A can be read out in a non-contact manner by a reader 8B in the present embodiment. The reader 8B is, for example, a device installed in the vehicle 1 and connected to the wheel load estimation device 2 so as to enable data communication. The reader 8B sends a request signal for requesting the tag 8A to transmit the type information, to the tag 8A. In response to the request signal, the tag 8A transmits the type information stored in the memory, to the reader 8B. Upon receiving the type information, the reader 8B notifies the wheel load estimation device 2 of the type information. Thus, the reader 8B can be composed of a known RFID reader or a known RFID reader/writer. The reader 8B and at least one tire including the tag 8A constitute a wheel load estimation system 10 according to the present embodiment, together with the wheel load estimation device 2.

In the present embodiment, the wheel loads of the tires T_{FL}, T_{FR}, T_{RL}, and T_{RR} are estimated at least based on the wheel speeds (rotation speeds) of the wheels FL, FR, RL, and RR. The wheels FL, FR, RL, and RR are each equipped with a wheel speed sensor 6, and the wheel speed sensor 6 detects, at a predetermined sampling period ΔT, information representing the wheel speed of the wheel (hereinafter referred to as wheel speed information) on which the wheel speed sensor 6 is mounted. The wheel speed sensor 6 is connected to the wheel load estimation device 2 via a communication line 5, and the wheel speed information detected by each wheel speed sensor 6 is transmitted to the wheel load estimation device 2 in real time.

As the wheel speed sensor 6, any sensor can be used as long as the sensor can detect the wheel speed of the wheel FL, FR, RL, or RR during running. For example, a sensor of a type that measures the wheel speed from an output signal of an electromagnetic pickup can be used, or a sensor of a type that generates power by using rotation, like a dynamo, and measures the wheel speed from the voltage at that time, can also be used. The mounting position of the wheel speed sensor 6 can be any position selected as appropriate according to the type of the sensor as long as it is possible to detect the wheel speed.

In the present embodiment, the current total weight of the vehicle 1 is estimated based on a wheel torque WT of the vehicle 1. In the present embodiment, the front-left wheel which is one drive wheel is equipped with a wheel torque sensor (hereinafter referred to as WT sensor) 7. The WT sensor 7 detects the wheel torque of the vehicle 1. The WT sensor 7 is connected to the wheel load estimation device 2 via the communication line 5, and information on the wheel torque detected by the WT sensor 7 is transmitted to the wheel load estimation device 2 in real time.

The WT sensor 7 can be any suitable sensor or the like so as long as the wheel torque of a drive wheel of the vehicle 1 can be detected. It is also possible to detect wheel torque without using the WT sensor 7, and, for example, wheel torque can alternatively or additional be estimated from engine torque acquired from a control device for an engine.

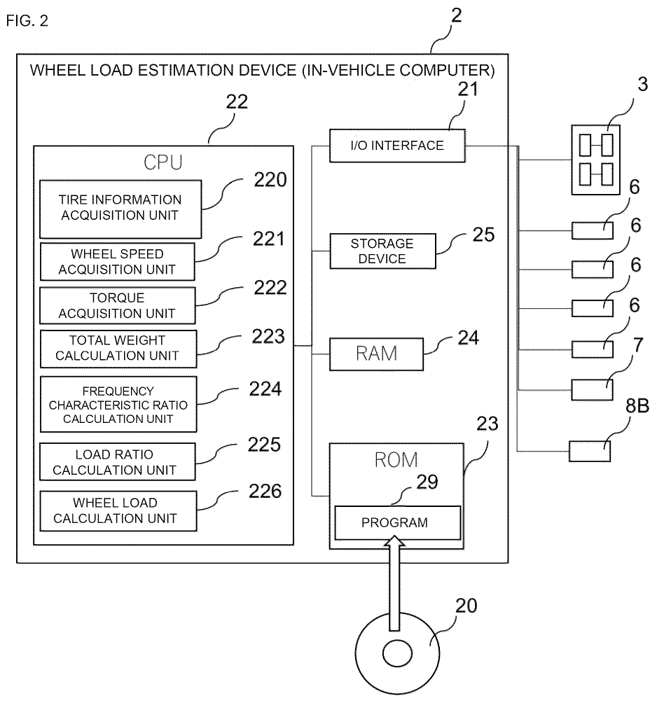

FIG. 2 is a block diagram showing the electrical configuration of the wheel load estimation device 2. As shown in FIG. 2, the wheel load estimation device 2 is an in-vehicle computer installed in the vehicle 1, and includes an I/O interface 21, a CPU (central processing unit) 22, a ROM (read only memory) 23, a RAM (random access memory) 24, and a nonvolatile rewritable storage device 25. The I/O interface 21 is a communication device for performing communication with external devices such as the wheel speed sensor 6, the WT sensor 7, and the warning indicator 3 described later. A program 29 for controlling the operation of each component of the vehicle 1 is stored in the ROM 23. The program 29 is written from a storage medium 20 such as a CD-ROM to the ROM 23. The CPU 22 reads out the program 29 from the ROM 23 and executes the program 29, thereby virtually operating as a tire information acquisition unit 220, a wheel speed acquisition unit 221, a torque acquisition unit 222, a total weight calculation unit 223, a frequency characteristic ratio calculation unit 224, a load ratio calculation unit 225, and a wheel load calculation unit 226. The details of the operations of the units 220 to 226 will be described later. The storage device 25 is composed of a hard disk, a flash memory, or the like. The storage place of the program 29 does not have to be the ROM 23, and may be the storage device 25. The RAM 24 and the storage device 25 are used as appropriate for the arithmetic operations of the CPU 22. Each “unit” as described herein may be implemented fully in particularly in or using circuitry. The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor. Further, as used herein, the term “circuitry” can refer to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present. This definition of “circuitry” can apply to all uses of this term in this application, including in any claims. As a further example, as used in this application, the term “circuitry” can also cover an implementation of merely a processor (or multiple processors) or portion of a processor and its (or their) accompanying software and/or firmware.

First relationship specification information and second relationship specification information for multiple types of tires that may be mounted on the wheels FL, FR, RL, and RR are stored in advance in the storage device 25 or the ROM 23 of the present embodiment. The first relationship specification information and the second relationship specification information can be regarded as information that is referenced by the wheel load estimation device 2 in wheel load estimation processing described later. The first relationship specification information and the second relationship specification information are specified in advance for each type of tire, based on data acquired in test runs conducted with a test vehicle of the same type as the vehicle 1 with different types of tires mounted on the wheels and different wheel load conditions for each tire, for example.

The warning indicator 3 can be realized in any form such as a liquid crystal display element or a liquid crystal monitor, as long as occurrence of unbalanced loading on the tires or the like can be notified to a user. The mounting position of the warning indicator 3 can also be selected as appropriate, for example, at a position, such as on an instrument panel, that can be easily recognized by a driver. In the case where the wheel load estimation device 2 is connected to a car navigation system, a monitor for car navigation can also be used as the warning indicator 3. In the case where a monitor is used as the warning indicator 3, a warning can be displayed on the monitor as an icon or text information.

### 2. Wheel Load Estimation Processing

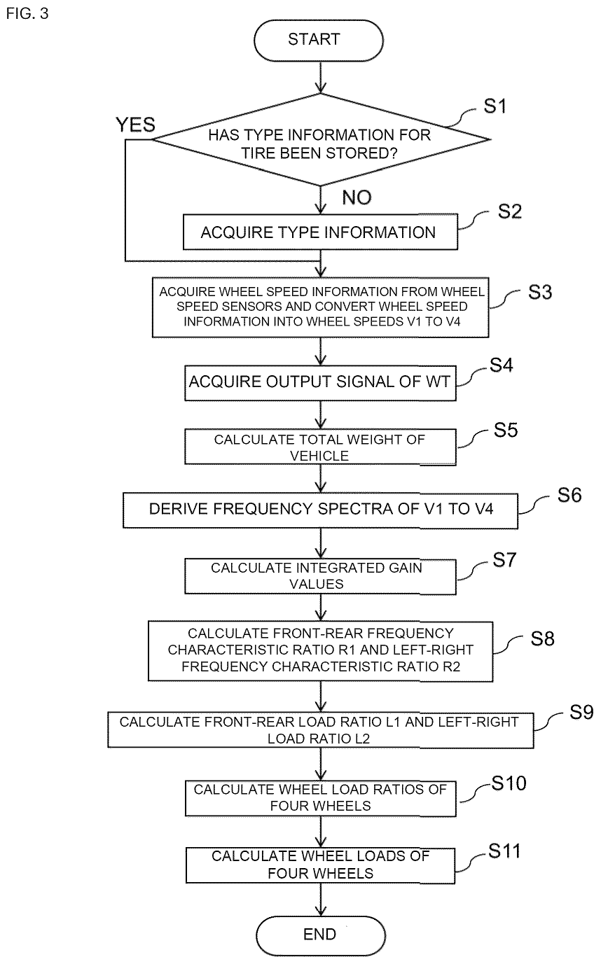

FIG. 3 is a flowchart showing the flow of the wheel load estimation processing according to one or more embodiments of the present disclosure. Hereinafter, the wheel load estimation processing for estimating the wheel loads of the tires T_{FL}, T_{FR}, T_{RL}, and T_{RR} will be described with reference to FIG. 3. The wheel load estimation processing shown in FIG. 3 starts when the vehicle 1 starts running, and stops when the vehicle 1 stops running, for example.

The tire information acquisition unit 220 may first determine whether or not at least one piece of the type information for the tires T_{FL}, T_{FR}, T_{RL}, and T_{RR} currently mounted on the wheels FL, FR, RL, and RR has already been stored in the storage device 25 (step S1). If it is determined that the at least one piece of the type information has already been stored in the storage device 25 (YES), step S3 is executed next. If it is determined that none of the type information for the tires T_{FL}, T_{FR}, T_{RL}, and T_{RR} has been stored in the storage device 25 (NO), step S2 is executed next.

In step S2, the tire information acquisition unit 220 acquires the at least one piece of the tire type information for the tires T_{FL}, T_{FR}, T_{RL}, and T_{RR}, which is stored in the tag 8A, via the reader 8B. The tire information acquisition unit 220 requests the reader 8B to transmit a request signal to the tag 8A and to forward the type information received from the tag 8A. Accordingly, the tire information acquisition unit 220 acquires the at least one piece of the type information for the tires T_{FL}, T_{FR}, T_{RL}, and T_{RR}, and stores the at least one piece of the type information in the storage device 25. The above request to the reader 8B may be executed as a trigger for the user (typically, the driver of the vehicle 1) to perform an operation on the wheel load estimation device 2. In this case, the tire information acquisition unit 220 may generate a screen promoting the user to perform a predetermined initialization operation (e.g., pressing a predetermined button, or the like) and display the screen on the warning indicator 3. In the present embodiment, once the type information is stored in the storage device 25, the same type information is referenced in subsequent wheel load estimation processing. Therefore, it may be preferable, in one or more embodiments, that the wheel load estimation device 2 is configured to be able to overwrite and update the type information as appropriate when the user performs the above initialization operation after tire replacement or the like.

In step S3, the wheel speed acquisition unit 221 acquires time-series rotation speed signals from the respective wheel speed sensors 6 mounted on the wheels FL, FR, RL, and RR. The wheel speed acquisition unit 221 converts the acquired rotation speed signals into rotation speeds V1 to V4 of the wheels FL, FR, RL, and RR (or the tires T_{FL}, T_{FR}, T_{RL}, and T_{RR}), respectively, and temporarily stores the rotation speeds V1 to V4 in the RAM 24 or stores the rotation speeds V1 to V4 in the storage device 25.

The torque acquisition unit 222 may acquire, subsequently or otherwise relative to the above, an output signal from the WT sensor 7 (step S4). The torque acquisition unit 222 temporarily stores the acquired output signal of the WT sensor 7 in the RAM 24, or stores the acquired output signal of the WT sensor 7 in the storage device 25. In addition, the torque acquisition unit 222 converts the output signal of the WT sensor 7 into a wheel torque.

The total weight calculation unit 223 may calculate, subsequently or otherwise relative to the above, a current total weight M of the vehicle 1 (step S5). In the present embodiment, the total weight M is calculated based on the following equation of motion. In the following equation, WT denotes the wheel torque derived in step S3. α denotes the front-rear acceleration of the vehicle 1 and is calculated from the wheel speeds V1 to V4. g denotes the gravitational acceleration, and θ denotes a road surface inclination. θ can be calculated, for example, from data from a satellite positioning system such as GPS installed in the vehicle 1.

$$WT = M α + Mg \cdot sin θ$$

Various methods are known as a method for estimating the total weight M of the vehicle 1, and thus the detailed description thereof is omitted here, but for better understanding, for example, Japanese Patent No. 5346659 and Japanese Patent No. 4926258 of this applicant, etc., may be referenced.

The frequency characteristic ratio calculation unit 224 may evaluate, subsequently or otherwise relative to the above, the frequency characteristics of waveform signals of the wheel speeds V1 to V4 (step S6). Specifically, the frequency characteristic ratio calculation unit 224 differentiates time-series data of the wheel speeds V1 to V4 over time to calculate accelerations A1 to A4, respectively. The accelerations A1 to A4 are the rotational accelerations of the wheels FL, FR, RL, and RR, respectively. The frequency characteristic ratio calculation unit 224 may perform, subsequently or otherwise relative to the above, a fast Fourier transform on the accelerations A1 to A4 to derive frequency spectra, respectively. The frequency characteristics can also be evaluated through time-series estimation with an autoregressive model, distribution of the time-series data, or the like, in addition to the fast Fourier transform processing.

The frequency characteristic ratio calculation unit 224 may calculate, subsequently or otherwise relative to the above, integrated gain values for the two front wheels (FL+FR), the two rear wheels (RL+RR), the two left wheels (FL+RL), and the two right wheels (FR+RR) based on the frequency spectra of the wheels FL, FR, RL, and RR derived in step S6 (step S7). As described above, the integrated gain value represents the magnitude of the gain. In the present embodiment, when calculating the integrated gain value, the frequency spectrum is integrated in a band from zero to the Nyquist frequency, but the integration may be performed in a limited band in which the influence of a load is significantly exhibited. In addition, the integration intervals for the front, rear, left, and right wheels do not necessarily have to be the same. Hereinafter, the integrated gain values of the two front wheels, the two rear wheels, the two left wheels, and the two right wheels are referred to as front wheel gain, rear wheel gain, left wheel gain, and right wheel gain, respectively.

The load ratio calculation unit 225 may calculate, subsequently or otherwise relative to the above, a front-rear frequency characteristic ratio R1 and a left-right frequency characteristic ratio R2 according to the following equations (step S8).

$$R 1 = rear wheel gain / front wheel gain$$

$$R 2 = right wheel gain / left wheel gain$$

The load ratio calculation unit 225 may calculate, subsequently or otherwise relative to the above, a front-rear load ratio L1 and a left-right load ratio L2 (step S9). More specifically, the load ratio calculation unit 225 reads out the first relationship specification information and the second relationship specification information from the storage device 25, based on the type information stored in the storage device 25. In the present embodiment, L1 and L2 may be calculated from R1 and R2, respectively, utilizing the facts that L1 and R1 can be in an approximately linear relationship and that L2 and R2 can be in an approximately linear relationship, such as disclosed in Japanese Laid-Open Patent Publication No. 2019-113373. Therefore, the first relationship specification information can be represented by constants c1 and d1 which specify the linear relationship between L1 and R1 as in the following equation, and the second relationship specification information can be represented by constants c2 and d2 which specify the linear relationship between L2 and R2 as in the following equation.

$$L 1 = c 1 \times R 1 + d 1$$

$$L 2 = c 2 \times R 2 + d 2$$

The load ratio calculation unit 225 may subsequently calculate a front axle load ratio x and a rear axle load ratio y, and calculates wheel load ratios L_{FL}, L_{FR}, L_{RL}, and L_{RR} based on x and y (step S10). The front axle load ratio x is the ratio of the sum of the wheel loads of the two front wheels to the total weight M of the vehicle 1. The rear axle load ratio y is the ratio of the sum of the wheel loads of the two rear wheels to the total weight M of the vehicle 1. x and y are calculated using the following equations.

$$x = 1 / ( 1 + L 1 )$$

$$y = 1 - x = L 1 / ( 1 + L 1 )$$

Also, the wheel load ratios L_{FL}, L_{FR}, L_{RL}, and L_{RR} calculated here are indices that respectively represent relative wheel loads between the wheels FL, FR, RL, and RR. In the present embodiment, the wheel load ratios L_{FL}, L_{FR}, L_{RL}, and L_{RR} are respectively defined as the ratios of the wheel loads of the wheels FL, FR, RL, and RR to the total weight M of the vehicle 1, and are calculated according to the following equations.

$${L}_{FL} = x / ( 1 + L 2 )$$

$${L}_{FR} = x - {L}_{FL}$$

$${L}_{RL} = y / ( 1 + L 2 )$$

$${L}_{RR} = y - {L}_{RL}$$

Subsequently, the wheel load calculation unit 226 calculates the wheel loads of the wheels FL, FR, RL, and RR according to the following equations, using the wheel load ratios L_{FL}, L_{FR}, L_{RL}, and L_{RR} and the total weight M of the vehicle 1 (step S11).

$$FL wheel \text{:} M \times {L}_{FL}$$

$$FL wheel \text{:} M \times {L}_{FR}$$

$$RL wheel \text{:} M \times {L}_{RL}$$

$$RR wheel \text{:} M \times {L}_{RR}$$

Accordingly, the wheel load estimation processing ends. However, the wheel load estimation device 2 may further determine whether or not unbalanced loading has occurred, based on at least either the wheel load ratios calculated in step S10 or the wheel loads calculated in step S11. If it is determined that unbalanced loading has occurred, the wheel load estimation device 2 may be configured to generate a warning and output the warning via the warning indicator 3.

### 3. Features

According to the above embodiment, the first relationship specification information and the second relationship specification information stored in advance in the wheel load estimation device 2 are referenced according to the tire type information, and the wheel load is estimated using the first relationship specification information and the second relationship specification information suitable for the combination of the vehicle 1 and the tire. Therefore, the wheel load can be estimated more accurately as compared to the case of using general-purpose data acquired in test runs under conditions of combinations of multiple types of vehicles 1 and multiple types of tires, as the first relationship specification information and the second relationship specification information.

### 4. Modifications

Embodiments of the present disclosure are not limited to the above embodiment(s), and various modifications can be made without departing from the gist of the present disclosure. For example, the following modifications can be possible. In addition, the gist of the following modifications can be combined as appropriate.

(1) The configurations of the tag 8A and the reader 8B are not limited to those of the above embodiment. For example, the tag 8A may be configured to transmit the type information in accordance with other wireless communication standards such as Bluetooth®. In this case, the reader 8B may be a mobile information terminal (smartphone, tablet, laptop computer, etc.) that is carried by the user and can be brought into the vehicle 1, or the wheel load estimation device 2 may also serve as the reader 8B.

(2) In the above embodiment, the wheel load ratio and the wheel load are calculated for each wheel, but these may be calculated only for some of the wheels FL, FR, RL, and RR. In addition, if only the wheel load ratio is required in another control system or the like of the vehicle 1, steps S4, S5, and S11 may be omitted.

(3) The order in which the steps of the wheel load estimation processing according to the above embodiment are executed can be changed as appropriate. For example, steps S4 and S5 may be executed before step S3.

(4) The method for calculating the front-rear load ratio L1 and the left-right load ratio L2 is not limited to the method of the above embodiment. For example, the front-rear load ratio L1 can be represented as a linear combination of the ratio between the integrated gain value of the two front wheels and the integrated gain value of the two rear wheels in a first frequency band and the ratio between the integrated gain value of the two front wheels and the integrated gain value of the two rear wheels in a second frequency band, each weighted by a predetermined coefficient. For exemplary details of this method, Japanese Laid-Open Patent Publication No. 2024-029666, which is a publication of an application filed by this applicant, may be referenced. When calculating the front-rear load ratio L1 using the method disclosed in this publication, the first relationship specification information is described as corresponding to the weighting coefficients for the integrated gain value ratio in the first frequency band and the integrated gain value ratio in the second frequency band. Similarly, when calculating the left-right load ratio (first left-right load ratio L2 and second left-right load ratio L3) using the method disclosed in the same publication, the second relationship specification information is described as corresponding to the weighting coefficients for the integrated gain value ratio in the first frequency band and the integrated gain value ratio in the second frequency band for the front left and right wheels and the weighting coefficients for the integrated gain value ratio in the first frequency band and the integrated gain value ratio in the second frequency band for the rear left and right wheels.

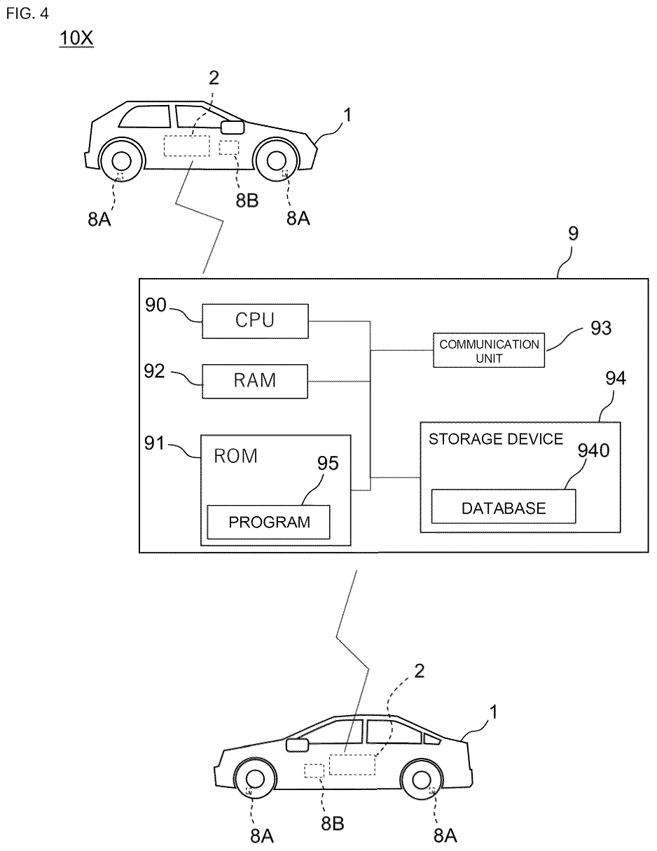

(5) In the above embodiment, the first relationship specification information and the second relationship specification information corresponding to the type information for multiple types of tires are stored in the storage device 25 of the wheel load estimation device 2. However, the first relationship specification information and the second relationship specification information may be stored not in the wheel load estimation device 2, but in a computer 9 to which the wheel load estimation device 2 is connected so as to enable data communication as shown in FIG. 4 and which is external to the vehicle 1. The computer 9 can be configured as a general-purpose server computer that is connected to wheel load estimation devices 2 in multiple vehicles 1, for instance, so as to enable data communication and transmits the first relationship specification information and the second relationship specification information in response to a request from each wheel load estimation device 2. The computer 9 may be regarded as constituting a wheel load estimation system 10× according to a modification, together with the wheel load estimation device 2, at least one tire including the tag 8A, and the reader 8B. The computer 9 includes a CPU 90, a ROM 91, a RAM 92, a communication unit 93, and a nonvolatile rewritable storage device 94. A program 95 for controlling the operation of the computer 9 is stored in the ROM 91, and the computer 9 serves as a server computer by the CPU 90 reading out and executing the program 95. The RAM 92 and the storage device 94 are used as appropriate for the arithmetic operations of the CPU 90. The communication unit 93 is a communication device for performing data communication with other computers such as the wheel load estimation devices 2.

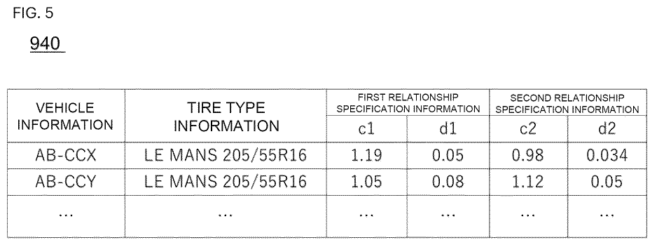

In the storage device 94, first relationship specification information and second relationship specification information are stored in association with multiple combinations of vehicle information and tire type information as shown in FIG. 5, for example. The vehicle information is information specifying the model of the vehicle in which the wheel load estimation device 2 is installed. That is, a database 940 of the first relationship specification information and the second relationship specification information corresponding to multiple combinations of vehicle 1 and tires is constructed in the storage device 94. The database 940, according to one or more embodiments, can be preferably updatable.

If it is determined as NO in step S1 in the above embodiment (i.e., if all of the type information for the tires T_{FL}, T_{FR}, T_{RL}, and T_{RR} has not been acquired), the tire information acquisition unit 220 of the wheel load estimation device 2 acquires at least one piece of the tire type information from each tag 8A in step S2, and transmits the vehicle information of the vehicle 1 in which the wheel load estimation device 2 is installed, to the computer 9 together with the acquired tire type information. Upon receiving the type information and the vehicle information from the wheel load estimation device 2, the computer 9 refers to the database 940, identifies the data of the first relationship specification information and the second relationship specification information that match the combination of the received type information and vehicle information, and transmits the data of the first relationship specification information and the second relationship specification information to the wheel load estimation device 2. Accordingly, the tire information acquisition unit 220 acquires the first relationship specification information and the second relationship specification information from the computer 9.

In the above embodiment, the device that communicates directly with the computer 9 may be a device other than the wheel load estimation device 2 that is connected to the wheel load estimation device 2 so as to enable data communication. For example, the reader 8B may acquire the tire type information from the tag 8A, transmit the type information to the computer 9 together with the vehicle information, and acquire the first relationship specification information and the second relationship specification information from the computer 9.

(6) The tire type information may be acquired by the wheel load estimation device 2, not from the tag 8A. For example, the tire information acquisition unit 220 may generate a screen for the user to input or select tire type information, display the screen on the warning indicator 3 or the like, and acquire tire type information based on an input or selection operation by the user. That is, each of the tires T_{FL}, T_{FR}, T_{RL}, and T_{RR} does not have to include the tag 8A.

(7) The tire type information does not have to be acquired for all tires included in the vehicle 1, and may be acquired for at least one tire included in the vehicle 1. That is, it is assumed that the same type of tires is mounted on the vehicle 1.

One or more embodiments of the present disclosure may may be regarded as comprising or consisting of calculating the front-rear and left-right frequency characteristic ratios from wheel speed information, and then calculating the front-rear and left-right load ratios using specification information determined according to the tire type.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon. The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Further, as used herein, the term “circuitry” can refer to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present. This definition of “circuitry” can apply to all uses of this term in this application, including in any claims. As a further example, as used in this application, the term “circuitry” can also cover an implementation of merely a processor (or multiple processors) or portion of a processor and its (or their) accompanying software and/or firmware.

Use of the terms “data,” “content,” “information” and similar terms may be used interchangeably, according to some example embodiments of the present disclosure, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Aspects of the present disclosure have been described above with reference to flowchart illustrations and/or block diagrams of methods, apparatus (systems) and computer program products according to embodiments of the present disclosure. In this regard, the flowchart and block diagrams in the Figures illustrate the architecture, functionality, and operation of possible implementations of systems, methods and computer program products according to various embodiments of the present disclosure. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosed subject matter can also be as set forth according to the following parentheticals.

(1) A wheel load estimation device configured to estimate a wheel load of a tire included in a vehicle, the wheel load estimation device comprising: circuitry configured to acquire type information specifying a type of the tire; acquire wheel speed information representing a wheel speed of each wheel of the vehicle; calculate a front-rear frequency characteristic ratio and a left-right frequency characteristic ratio, based on the wheel speed information, wherein the front-rear frequency characteristic ratio changes in accordance with a change in a front-rear load ratio, which is a ratio between a load applied to a front wheel of the vehicle and a load applied to a rear wheel of the vehicle, and the left-right frequency characteristic ratio changes in accordance with a change in a left-right load ratio, which is a ratio between a load applied to a left wheel of the vehicle and a load applied to a right wheel of the vehicle; calculate the front-rear load ratio and the left-right load ratio, based on the front-rear frequency characteristic ratio and the left-right frequency characteristic ratio, respectively; and calculate a wheel load ratio representing a relative wheel load between the wheels included in the vehicle, with respect to at least one wheel of the vehicle, based on the front-rear load ratio and the left-right load ratio, wherein the circuitry calculates the front-rear load ratio and the left-right load ratio, based on first relationship specification information specifying a relationship between the front-rear frequency characteristic ratio and the front-rear load ratio and second relationship specification information specifying a relationship between the left-right frequency characteristic ratio and the left-right load ratio, respectively, and the first relationship specification information and the second relationship specification information are determined according to the type of the tire.

(2) The wheel load estimation device according to (1) above, wherein at least one of the tires includes a tag in which the type information is electromagnetically stored.

(3) The wheel load estimation device according to (1) or (2) above, wherein
the first relationship specification information and the second relationship specification information are stored in a computer external to the vehicle, and
the circuitry acquires the first relationship specification information and the second relationship specification information from the external computer.

(4) The wheel load estimation device according to any one of (1) to (3) above, wherein
at least one of the tires includes a tag in which the type information is electromagnetically stored,
the first relationship specification information and the second relationship specification information are stored in a computer external to the vehicle, and
the circuitry acquires the first relationship specification information and the second relationship specification information from the external computer.

(5) A wheel load estimation system comprising:
the wheel load estimation device according to any one of (1) to (4) above;
at least one tire including a tag in which the type information is electromagnetically stored; and
a reader configured to read out the type information from the tag.

(6) The wheel load estimation device according to any one of (1) to (5) above, wherein at least one of the tires includes a tag in which the type information is electromagnetically stored.

(7) The wheel load estimation device according to any one of (1) to (6) above, wherein
the first relationship specification information and the second relationship specification information are stored in a computer external to the vehicle, and
the circuitry acquires the first relationship specification information and the second relationship specification information from the external computer.

(8) A wheel load estimation method, executed by one or more computers, for estimating a wheel load of a tire included in a vehicle, the wheel load estimation method comprising:
acquiring type information specifying a type of the tire;
acquiring wheel speed information representing a wheel speed of each wheel of the vehicle;
calculating a front-rear frequency characteristic ratio and a left-right frequency characteristic ratio, based on the wheel speed information, wherein the front-rear frequency characteristic ratio changes in accordance with a change in a front-rear load ratio, which is a ratio between a load applied to a front wheel of the vehicle and a load applied to a rear wheel of the vehicle, and the left-right frequency characteristic ratio changes in accordance with a change in a left-right load ratio, which is a ratio between a load applied to a left wheel of the vehicle and a load applied to a right wheel of the vehicle;
calculating the front-rear load ratio and the left-right load ratio, based on the front-rear frequency characteristic ratio and the left-right frequency characteristic ratio, respectively; and
calculating a wheel load ratio representing a relative wheel load between the wheels included in the vehicle, with respect to at least one wheel of the vehicle, based on the front-rear load ratio and the left-right load ratio, wherein
the calculating the front-rear load ratio and the left-right load ratio includes calculating the front-rear load ratio and the left-right load ratio, based on first relationship specification information specifying a relationship between the front-rear frequency characteristic ratio and the front-rear load ratio and second relationship specification information specifying a relationship between the left-right frequency characteristic ratio and the left-right load ratio, respectively, and
the first relationship specification information and the second relationship specification information are determined according to the type of the tire.

(9) The wheel load estimation method according to (8), wherein at least one of the tires includes a tag in which the type information is electromagnetically stored.

(10) The wheel load estimation method according to(8) or (9), wherein
the first relationship specification information and the second relationship specification information are stored in a computer external to the vehicle, and
the circuitry acquires the first relationship specification information and the second relationship specification information from the external computer.

(11) A non-transitory computer-readable storage medium having stored thereon instructions that, when executed by one or more processors, causes the one or more processors to perform a wheel load estimation method for estimating a wheel load of a tire included in a vehicle comprising:
acquiring type information specifying a type of the tire;
acquiring wheel speed information representing a wheel speed of each wheel of the vehicle;
calculating a front-rear frequency characteristic ratio and a left-right frequency characteristic ratio, based on the wheel speed information, wherein the front-rear frequency characteristic ratio changes in accordance with a change in a front-rear load ratio, which is a ratio between a load applied to a front wheel of the vehicle and a load applied to a rear wheel of the vehicle, and the left-right frequency characteristic ratio changes in accordance with a change in a left-right load ratio, which is a ratio between a load applied to a left wheel of the vehicle and a load applied to a right wheel of the vehicle;
calculating the front-rear load ratio and the left-right load ratio, based on the front-rear frequency characteristic ratio and the left-right frequency characteristic ratio, respectively; and
calculating a wheel load ratio representing a relative wheel load between the wheels included in the vehicle, with respect to at least one wheel of the vehicle, based on the front-rear load ratio and the left-right load ratio, wherein
the calculating the front-rear load ratio and the left-right load ratio includes calculating the front-rear load ratio and the left-right load ratio, based on first relationship specification information specifying a relationship between the front-rear frequency characteristic ratio and the front-rear load ratio and second relationship specification information specifying a relationship between the left-right frequency characteristic ratio and the left-right load ratio, respectively, and
the first relationship specification information and the second relationship specification information are determined according to the type of the tire.

(12) The non-transitory computer-readable storage medium according to (11) above, wherein at least one of the tires includes a tag in which the type information is electromagnetically stored.

(13) The non-transitory computer-readable storage medium according to (11) or (12) above, wherein
the first relationship specification information and the second relationship specification information are stored in a computer external to the vehicle, and
the circuitry acquires the first relationship specification information and the second relationship specification information from the external computer.

What is claimed is:

1. A wheel load estimation device configured to estimate a wheel load of a tire included in a vehicle, the wheel load estimation device comprising:
circuitry configured to
acquire type information specifying a type of the tire;
acquire wheel speed information representing a wheel speed of each wheel of the vehicle;
calculate a front-rear frequency characteristic ratio and a left-right frequency characteristic ratio, based on the wheel speed information, wherein the front-rear frequency characteristic ratio changes in accordance with a change in a front-rear load ratio, which is a ratio between a load applied to a front wheel of the vehicle and a load applied to a rear wheel of the vehicle, and the left-right frequency characteristic ratio changes in accordance with a change in a left-right load ratio, which is a ratio between a load applied to a left wheel of the vehicle and a load applied to a right wheel of the vehicle;
calculate the front-rear load ratio and the left-right load ratio, based on the front-rear frequency characteristic ratio and the left-right frequency characteristic ratio, respectively; and
calculate a wheel load ratio representing a relative wheel load between the wheels included in the vehicle, with respect to at least one wheel of the vehicle, based on the front-rear load ratio and the left-right load ratio, wherein
the circuitry calculates the front-rear load ratio and the left-right load ratio, based on first relationship specification information specifying a relationship between the front-rear frequency characteristic ratio and the front-rear load ratio and second relationship specification information specifying a relationship between the left-right frequency characteristic ratio and the left-right load ratio, respectively, and
the first relationship specification information and the second relationship specification information are determined according to the type of the tire.

2. The wheel load estimation device according to claim 1, wherein at least one of the tires includes a tag in which the type information is electromagnetically stored.

3. The wheel load estimation device according to claim 1, wherein
the first relationship specification information and the second relationship specification information are stored in a computer external to the vehicle, and
the circuitry acquires the first relationship specification information and the second relationship specification information from the external computer.

4. The wheel load estimation device according to claim 1, wherein
at least one of the tires includes a tag in which the type information is electromagnetically stored,
the first relationship specification information and the second relationship specification information are stored in a computer external to the vehicle, and
the circuitry acquires the first relationship specification information and the second relationship specification information from the external computer.

5. A wheel load estimation system comprising:
the wheel load estimation device according to claim 1;
at least one tire including a tag in which the type information is electromagnetically stored; and
a reader configured to read out the type information from the tag.

6. The wheel load estimation device according to claim 5, wherein at least one of the tires includes a tag in which the type information is electromagnetically stored.

7. The wheel load estimation device according to claim 5, wherein
the first relationship specification information and the second relationship specification information are stored in a computer external to the vehicle, and
the circuitry acquires the first relationship specification information and the second relationship specification information from the external computer.

8. A wheel load estimation method, executed by one or more computers, for estimating a wheel load of a tire included in a vehicle, the wheel load estimation method comprising:
acquiring type information specifying a type of the tire;
acquiring wheel speed information representing a wheel speed of each wheel of the vehicle;
calculating a front-rear frequency characteristic ratio and a left-right frequency characteristic ratio, based on the wheel speed information, wherein the front-rear frequency characteristic ratio changes in accordance with a change in a front-rear load ratio, which is a ratio between a load applied to a front wheel of the vehicle and a load applied to a rear wheel of the vehicle, and the left-right frequency characteristic ratio changes in accordance with a change in a left-right load ratio, which is a ratio between a load applied to a left wheel of the vehicle and a load applied to a right wheel of the vehicle;
calculating the front-rear load ratio and the left-right load ratio, based on the front-rear frequency characteristic ratio and the left-right frequency characteristic ratio, respectively; and
calculating a wheel load ratio representing a relative wheel load between the wheels included in the vehicle, with respect to at least one wheel of the vehicle, based on the front-rear load ratio and the left-right load ratio, wherein
the calculating the front-rear load ratio and the left-right load ratio includes calculating the front-rear load ratio and the left-right load ratio, based on first relationship specification information specifying a relationship between the front-rear frequency characteristic ratio and the front-rear load ratio and second relationship specification information specifying a relationship between the left-right frequency characteristic ratio and the left-right load ratio, respectively, and
the first relationship specification information and the second relationship specification information are determined according to the type of the tire.

9. The wheel load estimation method according to claim 8, wherein at least one of the tires includes a tag in which the type information is electromagnetically stored.

10. The wheel load estimation method according to claim 8, wherein
the first relationship specification information and the second relationship specification information are stored in a computer external to the vehicle, and
the circuitry acquires the first relationship specification information and the second relationship specification information from the external computer.

11. A non-transitory computer-readable storage medium having stored thereon instructions that, when executed by one or more processors, causes the one or more processors to perform a wheel load estimation method for estimating a wheel load of a tire included in a vehicle comprising:
acquiring type information specifying a type of the tire;
acquiring wheel speed information representing a wheel speed of each wheel of the vehicle;
calculating a front-rear frequency characteristic ratio and a left-right frequency characteristic ratio, based on the wheel speed information, wherein the front-rear frequency characteristic ratio changes in accordance with a change in a front-rear load ratio, which is a ratio between a load applied to a front wheel of the vehicle and a load applied to a rear wheel of the vehicle, and the left-right frequency characteristic ratio changes in accordance with a change in a left-right load ratio, which is a ratio between a load applied to a left wheel of the vehicle and a load applied to a right wheel of the vehicle;
calculating the front-rear load ratio and the left-right load ratio, based on the front-rear frequency characteristic ratio and the left-right frequency characteristic ratio, respectively; and
calculating a wheel load ratio representing a relative wheel load between the wheels included in the vehicle, with respect to at least one wheel of the vehicle, based on the front-rear load ratio and the left-right load ratio, wherein
the calculating the front-rear load ratio and the left-right load ratio includes calculating the front-rear load ratio and the left-right load ratio, based on first relationship specification information specifying a relationship between the front-rear frequency characteristic ratio and the front-rear load ratio and second relationship specification information specifying a relationship between the left-right frequency characteristic ratio and the left-right load ratio, respectively, and
the first relationship specification information and the second relationship specification information are determined according to the type of the tire.

12. The non-transitory computer-readable storage medium according to claim 11, wherein at least one of the tires includes a tag in which the type information is electromagnetically stored.

13. The non-transitory computer-readable storage medium according to claim 11, wherein
the first relationship specification information and the second relationship specification information are stored in a computer external to the vehicle, and
the circuitry acquires the first relationship specification information and the second relationship specification information from the external computer.
